(19) United States
(12) Patent Application Publication
(10) Pub. No.: US 2025/0294112 A1
(43) Pub. Date: Sep. 18, 2025

(54) EFFECT VIDEO GENERATION METHOD AND APPARATUS, ELECTRONIC DEVICE, AND STORAGE MEDIUM

(71) Applicant: Beijing Zitiao Network Technology Co., Ltd., Haidian District, Beijing (CN)

(72) Inventors: Jiawei Wen, Beijing (CN); Hengkai Guo, Beijing (CN)

(21) Appl. No.: 18/862,913

(22) PCT Filed: May 5, 2023
(86) PCT No.: PCT/CN2023/092168

§ 371 Date: Nov. 4, 2024

(30) Foreign Application Priority Data
May 7, 2022 (CN) 202210494748.6

(51) Int. Cl. H04N 5/262

(52) U.S. Cl. CPC H04N 5/262

(57) ABSTRACT

The present disclosure provides an effect video generation method and apparatus, an electronic device, and a storage medium. The effect video generation method includes: when it is detected that a current video frame to be processed includes point cloud data to be processed, determining distance information between the point cloud data to be processed and at least one historically estimated plane; and in a case that the distance information and a data volume of the point cloud data to be processed satisfy a plane estimation condition, performing plane estimation on the point cloud data to be processed on the basis of a random sample consensus algorithm to generate a target estimated plane, so as to display, based on each estimated plane, a target effect corresponding to the current video frame to be processed and obtain a target effect video frame.

### CROSS-REFERENCE TO RELATED APPLICATION(S)

This application claims priority to Chinese Patent Application No. 202210494748.6, filed with the China National Intellectual Property Administration on May 7, 2022, the disclosure of which is incorporated herein by reference in its entirety.

### FIELD

The present disclosure relates to the technical field of image processing, e.g., to an effect video generation method and apparatus, an electronic device, and a storage medium.

### BACKGROUND

With the continuous development of network technology, more and more application programs have entered the lives of users, especially a series of software that can take short videos. The software is deeply loved by users.

To increase the fun of video taking, an application program further provides a user with a function of adding effects to videos. It can be understood that the application program first constructs a plane in a virtual space based on 3-dimension (3D) information (such as point cloud data), and then loads an effect selected by the user to the plane. However, as the amount of obtained 3D information continues to increase, the application program still rigidly loads the effects to the single constructed plane. The effect adding operation has a significant limitation and cannot meet the diversified demand of the user.

### SUMMARY

The present disclosure provides an effect video generation method and apparatus, an electronic device, and a storage medium, which achieves a technical effect of constructing a plurality of planes dynamically in a three-dimension space, so that the flexibility of an effect adding operation is improved, the diversified demand of a user is met, and the user experience is enhanced.

An embodiment of the present disclosure provides an effect video generation method, including:
in a case that it is detected that a current video frame to be processed includes point cloud data to be processed, determining distance information between the point cloud data to be processed and at least one historically estimated plane, wherein the at least one historically estimated plane is determined based on historical point cloud data to be processed; and
if the distance information and a data volume of the point cloud data to be processed satisfy a plane estimation condition, performing plane estimation on the point cloud data to be processed based on a random sample consensus algorithm to generate a target estimated plane, so as to display, based on each estimated plane, a target effect corresponding to the current video frame to be processed and obtain a target effect video frame.

An embodiment of the present disclosure provides an effect video generation apparatus, including:
a distance information determining module, configured to: in a case that it is detected that a current video frame to be processed includes point cloud data to be processed, determine distance information between the point cloud data to be processed and at least one historically estimated plane, wherein the at least one historically estimated plane is determined based on historical point cloud data to be processed; and
a target estimated plane generation module, configured to: if the distance information and a data volume of the point cloud data to be processed satisfy a plane estimation condition, perform plane estimation on the point cloud data to be processed based on a random sample consensus algorithm to generate a target estimated plane, so as to display, based on each estimated plane, a target effect corresponding to the current video frame to be processed and obtain a target effect video frame.

An embodiment of the present disclosure provides an electronic device. The electronic device includes:
one or more processors; and
a storage apparatus, configured to store one or more programs,
wherein the one or more programs, when executed by the one or more processors, cause the one or more processors to implement the effect video generation method described in any of the embodiments of the present disclosure.

An embodiment of the present disclosure further provides a storage medium including computer-executable instructions. The computer-executable instructions, when executed by a computer processor, are configured to implement the effect video generation method described in any of the embodiments of the present disclosure.

### BRIEF DESCRIPTION OF THE DRAWINGS

FIG. 1 is a flowchart of an effect video generation method according to Embodiment I of the present disclosure;

FIG. 2 is a flowchart of an effect video generation method according to Embodiment II of the present disclosure;

FIG. 3 is a schematic structural diagram of an effect video generation apparatus according to Embodiment III of the present disclosure; and

FIG. 4 is a schematic structural diagram of an electronic device according to Embodiment IV of the present disclosure.

### DETAILED DESCRIPTION OF EMBODIMENTS

The embodiments of the present disclosure will be described below with reference to the accompanying drawings. Although the accompanying drawings show some embodiments of the present disclosure, the present disclosure can be implemented in various forms should not be explained as being limited to the embodiments stated herein. Rather, these embodiments are provided for understanding the present disclosure. The accompanying drawings and embodiments of the present disclosure are only used for illustration, but are not intended to limit the protection scope of the present disclosure.

Multiple steps recorded in method implementations of the present disclosure can be executed in different orders and/or in parallel. In addition, the method implementations may include additional steps and/or omit the execution of the steps shown. The scope of the present disclosure is not limited in this aspect.

The term “include” and its variants as used herein mean widespread inclusion, namely, “including but not limited to”. The term “based on” is “based at least in part on”. The term “one embodiment” means “at least one embodiment”. The term “another embodiment” means “at least another embodiment”. The term “some embodiments” means “at least some embodiments”. Relevant definitions of other terms will be given in the description below.

The concepts such as “first” and “second” mentioned in the present disclosure are only used to distinguish different apparatuses, modules, or units, and are not intended to limit the order or interdependence of the functions performed by these apparatuses, modules, or units. The modifications of “one” and “plurality” mentioned in the present disclosure are indicative rather than restrictive, and unless otherwise stated in the context, they should be understood as “one or more”.

Messages or names of information exchanged between a plurality of apparatuses in the implementations of the present disclosure are only for illustrative purposes and are not intended to limit the messages or the scope of the information.

Before use of the technical solutions disclosed in multiple embodiments of the present disclosure, users should be informed of the type, scope of use, usage scenarios, and the like of personal information involved in the present disclosure in accordance with relevant laws and regulations in an appropriate manner, so as to obtain authorization from the users.

For example, in response to receiving an active request of a user, prompt information is sent to the user to clearly remind the user that personal information of the user needs to be involved in an operation requested to be executed. Thus, the user can independently select whether to provide the personal information to software or hardware such as an electronic device, an application program, a server, or a storage medium that performs the operation of the technical solutions of the present disclosure according to the prompt information.

As an optional but non-restrictive implementation, in response to receiving an active request of a user, prompt information is sent to the user through, e.g., a pop-up window where the prompt information can be presented in text. In addition, the pop-up window can also carry a selection control for the user to select whether to “agree” or “refuse” to provide the personal information to the electronic device.

The above notification and the above user authorization obtaining process are only illustrative and do not constitute a limitation on the implementations of the present disclosure. Other methods that meet the relevant laws and regulations can also be applied to the implementations of the present disclosure.

Before introduction of this technical solution, exemplary explanations can be provided for application scenarios of the embodiments of the present disclosure. Exemplarily, when a user takes a video through application software or makes a video call with another user, there may be a personalized demand for adding an effect into a current video picture with a high degree of freedom. However, in the related technology, the application can only construct, based on 3D information (such as point cloud data), a single plane used for carrying effects, which cannot meet the above demand of the user. At this time, according to the technical solution of the present embodiment, the application can construct a plurality of corresponding planes dynamically in the process of continuously obtaining the 3D information, namely, provide the user with a plurality of objects used for carrying effects, so as to meet the demand of the user for adding effects according to an expectation of the user and making an effect video.

### Embodiment I

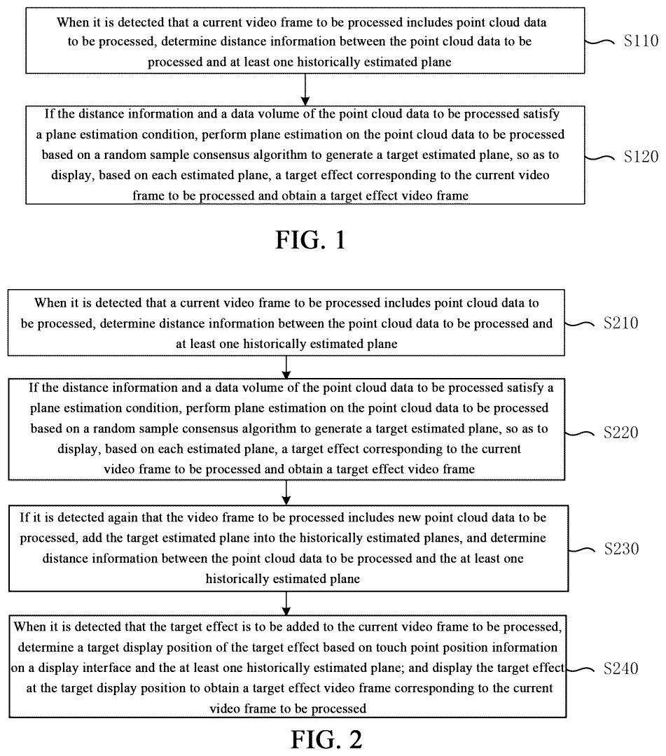

FIG. 1 is a flowchart of an effect video generation method provided by Embodiment I of the present disclosure. This embodiment of the present disclosure is applicable to a situation where an application constructs a plurality of planes dynamically in a process of continuously obtaining point cloud data. The method can be performed by an effect video generation apparatus. The apparatus can be implemented in the form of software and/or hardware. Optionally, the apparatus is implemented through an electronic device. The electronic device can be a mobile terminal, a personal computer (PC) end, a server, or the like.

As shown in FIG. 1, the method includes the following steps:

S110. When it is detected that a current video frame to be processed includes point cloud data to be processed, distance information between the point cloud data to be processed and at least one historically estimated plane is determined.

The apparatus for performing the effect video generation method provided by this embodiment of the present disclosure can be integrated in the application software that supports an effect video processing function. The software can be installed in the electronic device. Optionally, the electronic device may be a mobile terminal, a PC end, or the like. The application software may be application software for processing images/videos. The specific application software will not be elaborated here, as long as it can process images/videos. The application software can alternatively be specially developed application programs to add and display effects, or integrated into a corresponding page. A user can process effects videos through a page integrated in the PC end.

In this embodiment, a user can take a depth video based on a camera device of the mobile terminal, and each video frame obtained is a video frame to be processed. It can be understood that each frame picture of a deep video contains color information and depth information of a captured target region. Based on this, the application can detect and obtain corresponding point cloud data (PCD) at a plurality of moments in the video taking process of the user based on a point cloud computing technology. The point cloud data is commonly used in reverse engineering and is a type of data recorded in the form of points. These points can be coordinates in a three-dimension space, or can be information such as colors or illumination intensity. In a practical application process, the point cloud data generally includes a point coordinate accuracy, a spatial resolution, a surface normal vector, and the like. The point cloud data is generally saved in a PCD format. In this format, the point cloud data has high operability and can increase the speed of point cloud data processing (such as calibration and fusion of the point cloud data) in a subsequent process. In this embodiment, for a video frame to be processed at any moment, the application can determine point cloud data to be processed in the video frame in real time based on a simultaneous localization and mapping (SLAM) technology.

In this embodiment, the application can construct one or more planes in a virtual three-dimension space by using point cloud data detected from one or more video frames to be processed. It can be understood that the process of plane construction is a process of plane estimation, and these point cloud data that serve as a data foundation are the point cloud data to be processed. The plane estimation refers to: when a large number of 3D spatial points are detected, a system estimates the planes by using a specific algorithm until no sufficient 3D spatial points are detected in the system. The following takes an example for explanation: the application detects point cloud data to be processed from a single video frame to be processed corresponding to a current moment, and performs plane estimation based on the data.

In this embodiment, when the application detects the point cloud data to be processed within a current video frame to be processed, distance information between the point cloud data and each historically estimated plane in the virtual three-dimension space needs to be determined. The historically estimated plane is determined based on historical point cloud data to be processed. It can be understood that a plurality of video frames before the current moment also include a large amount of point cloud data, and the application has already constructed one or more planes in the virtual three-dimension space based on these point cloud data. Therefore, for the current moment, the constructed one or more planes are the historically estimated plane(s).

The process of determining the distance information between the point cloud data and each historically estimated plane can be understood as: determining whether to fuse these points to the historically estimated plane or to reconstruct a new estimated plane. During the determination of the distance information, optionally, the distance information between the point cloud data to be processed and the at least one historically estimated plane is determined based on coordinate information of the point cloud data to be processed and plane information of the at least one historically estimated plane.

Before the distance information between the point cloud data and each historically estimated plane is determined, a plane equation needs to be created. It can be understood that a plane in the 3D space can be uniquely defined by a point on the plane and a normal perpendicular to the plane. Based on this, a normal vector \vec{n}=(a,b,c) and a point p₁(x₁,y₁,z₁) on a plane are first defined. For any point p(x,y,z) on the plane, a vector from p₁ pointing to p can be defined on the plane, namely:

$$\vec{p} - \vec{{p}_{1}} = ( x - {x}_{1} , y - {y}_{1} , z - {z}_{1} ) .$$

Since the normal \vec{n} is perpendicular to the plane, the normal is inevitably perpendicular to the vector \vec{p}-\vec{p₁} located on the plane, and a dot product of the normal and the vector is 0, namely:

$$\vec{n} \cdot ( \vec{p} - \vec{{p}_{1}} ) = 0.$$

The above formula is a vector form of the plane equation. Correspondingly, it can be obtained through dot product calculation:

$$( a , b , c ) \cdot ( x - {x}_{1} , y - {y}_{1} , z - {z}_{1} ) = 0.$$

Based on the above formula, it can be inferred that:

$$a x + b y + c z - ( a {x}_{1} + {by}_{1} + {cz}_{1} ) = 0.$$

A constant part in the plane equation is replaced by d=−(ax₁+by₁+cz₁), thus an algebraic form of the plane equation is obtained as:

$$a x + b y + c z + d = 0 .$$

If the above normal is a normalized normal, a constant expression d in the plane equation is a distance from an origin to the plane. After a normalized normal vector \vec{:n}=(a₁, b₁, c₁) and a point p₁(Da₁, Db₁, Dc₁) on the plane are given, the above normal vector and the point are substituted into the plane equation, there is:

$$( {a}_{1} , {b}_{1} , {c}_{1} ) \cdot ( x - {Da}_{1} , y - {Db}_{1} , z - {Dc}_{1} ) = 0.$$

Based on the above formula, it can be inferred that:

$${a}_{1} x + {b}_{1} y + {c}_{1} z - D = 0.$$

Based on this, the distance from the origin to the plane can be calculated by dividing a standard plane equation by a modulus of the normal (a length of the normal). For example, based on the above formula, it can be calculated that the distance from the origin to plane (x+2y+2z−6=0) with a normal (1, 2, 2) is 2.

After obtaining the above formula, the distance D from any point p₂(x₂, y₂, z₂) in the space to the plane can be calculated, where θ is a plane included angle, namely:

$$D = \vert \vec{{p}_{2}} - \vec{{p}_{1}} \vert cos θ = \frac{\vec{n} \cdot ( \vec{{p}_{2}} - \vec{{p}_{1}} )}{\vert \vec{n} \vert} = \frac{\vec{n} \cdot ( \vec{{p}_{2}} - \vec{{p}_{1}} )}{\sqrt{{a}^{2} + {b}^{2} + {c}^{2}}} .$$

Based on the above calculation formula, the distance D is obtained by substituting point p₂ into the plane equation and dividing the plane equation by the modulus of the normal. For example, based on the above formula, it can be calculated that the distance from point (−1, −2, −3) to the plane (x+2y+2z−6=0) is −17/3. In a practical application process, the calculated distance has a symbol. The application can determine, based on the symbol, which side of a historically estimated plane each point in the point cloud data to be processed is located on. For example, if the distance corresponding to a point is greater than zero, it indicates that the point is on a front side of a historically estimated plane (i.e., a side pointed by the normal). Correspondingly, if the distance corresponding to the point is less than zero, it indicates that the point is on a back side of the historically estimated plane (i.e., an opposite side of the normal). If the distance corresponding to the point is zero, it indicates that the point is on the historically estimated plane.

It can be understood that for each other point in the point cloud data, distance information from the point to a historically estimated plane can also be determined according to the above calculation manner. Meanwhile, when there are a plurality of historically estimated planes in the virtual three-dimension space, for each point in the point cloud data, the application further needs to determine distance information between the point and each historically estimated plane according to the above calculation manner. This embodiment of the present disclosure will not elaborate this.

S120. If the distance information and a data volume of the point cloud data to be processed satisfy a plane estimation condition, plane estimation is performed on the point cloud data to be processed based on a random sample consensus algorithm to generate a target estimated plane, so as to display, based on each estimated plane, a target effect corresponding to the current video frame to be processed and obtain a target effect video frame.

In this embodiment, after the distance information between each point in the point cloud data and each historically estimated plane is determined, the application further needs to determine whether the distance information and the data volume of the point cloud data to be processed satisfy the plane estimation condition. It can be understood as determining the distance between each point in the point cloud data and each historically estimated plane, and then determining whether a new estimated plane needs to be constructed based on the point cloud data to be processed. This process will be explained below.

Optionally, if the distance information is greater than a preset distance threshold in the plane estimation condition, the data volume of the point cloud data to be processed is accumulated to obtain a current data volume; and if the current data volume reaches a data volume threshold in the plane estimation condition, plane estimation processing is performed, based on the random sample consensus algorithm, on each piece of currently stored point cloud data to be processed to generate the target estimated plane.

Exemplarily, the application can preset a distance threshold. The threshold can be regarded as a critical value, which is used to determine whether a point needs to be fused to the historically estimated plane. When it is calculated that the distance information between a point in the point cloud data to be processed is greater than the preset distance threshold, it indicates that the point does not need to be fused to the historically estimated plane. Meanwhile, when a large number of points in the point cloud data to be processed is determined based on the preset distance threshold, if it is determined that the distance information corresponding to a plurality of points is greater than the preset distance threshold, the application further needs to accumulate the data volume of these points to determine the current data volume in real time. The accumulated point cloud data can be stored in a cache or a specific storage space. This embodiment of the present disclosure will not elaborate this here.

In this embodiment, the current data volume is a parameter used for determining whether to construct a new estimated plane based on the point cloud data to be processed. The application can preset a data volume threshold. If the current data volume reaches the data volume threshold in the plane estimation condition, it indicates that the application can construct a new estimated plane, namely the target estimated plane, based on the accumulated point cloud data to be processed. In a practical application process, the application can use the Random Sample Consensus (RANSAC) algorithm to perform the plane estimation on the accumulated point cloud data to be processed. Based on the RANSAC algorithm, the application can iteratively estimate parameters of a mathematical model from a group of observed data (i.e. the accumulated point cloud data to be processed) including outliers, namely, parameters used for generating the target estimated plane. The RANSAC algorithm first assumes that the point cloud data to be processed includes both correct data and anomalous data (also referred to as noise), and marks the correct data as inliers and the anomalous data as outliers. Meanwhile, the RANSAC further assumes that a group of correct data is given and there is a method for calculating model parameters that are in line with the point cloud data to be processed, thereby generating the target estimated plane.

In this embodiment, for the accumulated point cloud data to be processed, the application can generate both one target estimated plane and a plurality of target estimated planes based on the RANSAC algorithm. It can be understood that when the application only generates one target estimated plane, it indicates that the distances between the points in the accumulated point cloud data to be processed and the target estimated plane are all less than the preset distance threshold. However, when the application generates a plurality of target estimated planes, it indicates that the distances between only a portion of the points in the accumulated point cloud data to be processed and one target estimated plane are less than the preset distance threshold, and the distances between other points and the target estimated plane are greater than the preset distance threshold. Therefore, other target estimated planes need to be constructed based on these points.

If the current data volume does not reach the data volume threshold, the current data volume is accumulated, and the point cloud data to be processed is stored. When the current data volume reaches the data volume threshold, the stored point cloud data to be processed is subjected to the plane estimation processing to obtain the target estimated plane. It can be understood that before an effect video is generated, the application can apply for a space in a specific storage space or an internal memory in advance. When the current data volume does not reach the data volume threshold, the accumulated point cloud data will be stored in the above storage space or the internal memory. Meanwhile, the stored data volume will be detected in real time. When it is determined that the data volume reaches the data volume threshold, the application can generate the target estimated plane in the above way. This embodiment of the present disclosure will not elaborate this here.

In an actual process of determining the distance information between a point in the point cloud data to be processed and a historically estimated plane, there is still a situation where the distance information is less than the preset distance threshold. Optionally, if the distance information is less than the preset distance threshold in the plane estimation condition, a target historically estimated plane corresponding to the point cloud data to be processed is determined, and the point cloud data to be processed is fused to the target historically estimated plane. It can be understood that for points with the distance information less than the preset distance threshold, the application does not need to generate a new target estimated plane in the virtual three-dimension space based on these points, and only needs to fuse these points to historically estimated planes closest to these points. Such historically estimated planes are the target estimated planes.

In a case that the distance information is equal to the preset distance threshold in the plane estimation condition, a target historically estimated plane corresponding to the point cloud data to be processed can be determined, and the point cloud data to be processed is fused to the target historically estimated plane.

Before the points in the point cloud data to be processed are fused to the corresponding target historically estimated plane, the points further needs to be calibrated. To be specific, a large number of points are superimposed and matched to a unified coordinate system, and corresponding translation values and rotation matrices are calculated to eliminate redundant information. The calibration of the point cloud data to be processed can be divided into three types: rough calibration, fine calibration, and global calibration according to different image inputting conditions and reconstruction output requirements. After the calibration of the point cloud data to be processed is completed, the application can fuse the calibrated point cloud data to be processed based on a pre-written point cloud fusion program, namely, fuse each point to the historically estimated plane closest to the point.

In this embodiment, after determining a plurality of estimated planes in the virtual three-dimension space, the application detects a triggering operation of a user in real time, thereby loading a target effect selected by the user onto the corresponding estimated plane, to achieve an effect of adding the effect to a video frame according to the expectation of the user.

The application can provide the user with a plurality of effect templates in advance. It can be understood that each effect template is associated with a corresponding 2D (2-dimension) texture or 3D model, such as a cartoon illustration or a 3D zoosemy model. Meanwhile, a plurality of effect templates can be further associated with a plurality of pre-developed controls in the application after being labeled with identifiers used for representing names of effects. Based on this, when a user selects an effect as a target effect through a control at a moment corresponding to the current video frame, the application can load a 2D texture or 3D model associated with the effect onto any estimated plane according to an actual need of the user, and then write information of each point in a video frame to be processed and information of each point on the texture or model into a rendering engine, so that the rendering engine renders a target effect video frame corresponding to the video frame to be processed of the current moment. The rendering engine can be a program that controls a Graphics Processing Unit (GPU) to render relevant images. In this embodiment, when the information of each point is written into the rendering engine, a computer can be caused to complete a drawing task of the target effect video frame under the driving of the rendering engine. This embodiment of the present disclosure will not elaborate this here.

According to the technical solution of this embodiment of the present disclosure, the distance information between the point cloud data to be processed and the at least one historically estimated plane is determined when it is detected that the current video frame to be processed includes the point cloud data to be processed. If the distance information and the data volume of the point cloud data to be processed satisfy the plane estimation condition, the random sample consensus algorithm is used to perform the plane estimation on the point cloud data to be processed to generate the target estimated plane. A target effect corresponding to the current video frame to be processed is displayed based on each estimated plane to obtain the target effect video frame. This achieves the technical effect of dynamically constructing a plurality of planes in the three-dimension space, thus not only improving the flexibility of an effect adding operation, but also meeting the diversified demand of a user and enhancing the user experience.

### Embodiment II

FIG. 2 is a flowchart of an effect video generation method according to Embodiment II of the present disclosure. Based on the foregoing embodiment, when the application detects point cloud data to be processed again in a subsequent process, the estimated planes in the virtual three-dimension space can be dynamically updated. A target display position of the target effect can be determined based on a touch point position, so that the flexibility of adding an effect is improved, and the personalized demand of a user in an effect video making process is easier met. An actual implementation can be found in the technical solution of this embodiment. Technical terms that are the same as or correspond to those in the above embodiment will not be elaborated here.

As shown in FIG. 2, the method includes the following steps:

S210. When it is detected that a current video frame to be processed includes point cloud data to be processed, distance information between the point cloud data to be processed and at least one historically estimated plane is determined.

S220. If the distance information and a data volume of the point cloud data to be processed satisfy a plane estimation condition, plane estimation is performed on the point cloud data to be processed based on a random sample consensus algorithm to generate a target estimated plane, so as to display, based on each estimated plane, a target effect corresponding to the current video frame to be processed and obtain a target effect video frame.

S230. If it is detected again that the video frame to be processed includes new point cloud data to be processed, the target estimated plane is added into the historically estimated planes, and distance information between the point cloud data to be processed and the at least one historically estimated plane is determined.

In this embodiment, the target estimated plane and the historically estimated plane are a relative concept. It can be understood that in the subsequent process, the target estimated plane generated at the current moment is a historically estimated plane.

If one or more target estimated planes have been generated based on the point cloud data in the video frame to be processed at the current moment, in a subsequent video taking process of a user, the application can further dynamically determine a plurality of video frame to be processed and detect content of the plurality of video frames. Meanwhile, the target estimated planes are used as historically estimated planes. For example, in a case that there are ten historically estimated planes in the virtual three-dimension space, the application generates two target estimated planes based on the point cloud data to be processed of the video frame to be processed at the current moment. In the subsequent process, for point cloud data to be processed that is detected again, the two target estimated planes will be used as historically estimated planes too. Namely, there are twelve historically estimated planes in the virtual 3D space in total.

Based on this, when the application detects point cloud data to be processed again in the video frame to be processed, distance information between each point in the new point cloud data to be processed and at least one historically estimated plane can be determined according to the method in Embodiment I of the present disclosure. Then, the distance information is judged based on a preset distance threshold to determine whether to fuse these points to a nearest historically estimated plane or to regenerate a target estimated plane based on these points.

The application can save a target estimated plane that is newly generated based on point cloud data to be processed in a video frame to be processed at any moment. In this way, when the point cloud data to be processed corresponding to any estimated plane is detected in a subsequent video frame to be processed, the corresponding estimated plane can be reused without regeneration, thus avoiding the waste of computing resources and improving the efficiency of processing an effect video.

S240. When it is detected that the target effect is to be added to the current video frame to be processed, a target display position of the target effect is determined based on touch point position information on a display interface and the at least one historically estimated plane; and the target effect is displayed at the target display position to obtain a target effect video frame corresponding to the current video frame to be processed.

The target effect can also be an Augmented Reality (AR) effect. When it is detected that the AR effect is added to the current video frame to be processed, the application can determine touch point position information. Meanwhile, the application can determine, based on a plurality of historically estimated planes contained in the three-dimension space, a target display position of the AR effect in the space. The target display position is a position used for carrying a 3D model corresponding to the AR effect.

Exemplarily, the current three-dimension space contains an estimated plane corresponding to a ground and an estimated plane corresponding to a desktop. Based on this, when the application detects the ouch point position information, a ray can be emitted from the touch point position used as an origin into the three-dimension space, and then an intersection point of the ray and one of the estimated planes is used as the target display position. For example, when the ray intersects with the estimated plane corresponding to the desktop, it indicates that the AR effect needs to be displayed on the desktop according to a need of a user. A plurality of estimated planes for carrying AR effects are generated. This not only improves the flexibility of adding an AR effect and avoids the problems of only constructing a single plane in a space and a position of an added AR effect being fixed, but also meets the personalized demand of a user in an effect video making process.

In this embodiment, once the target display position of the target effect is determined, the application can load, based on this position, a 2D texture or 3D model associated with the target effect, thereby sending information of each point in a video frame loaded with the effect to a rendering engine, so as to perform rendering according to the method of Embodiment I of the present disclosure to obtain the target effect video frame.

According to the technical solution of this embodiment, when the application detects the point cloud data to be processed again in a subsequent process, the application needs to continue to determine the distance between each point and the historically estimated plane, and fuse each point to the historically estimated plane, or construct a new target estimated plane, thereby dynamically updating the estimated planes in the virtual three-dimension space. The application determines the target display position of the target effect based on the touch point position information. This improves the flexibility of adding an effect and more easily meets the personalized demand of a user in an effect video making process.

### Embodiment III

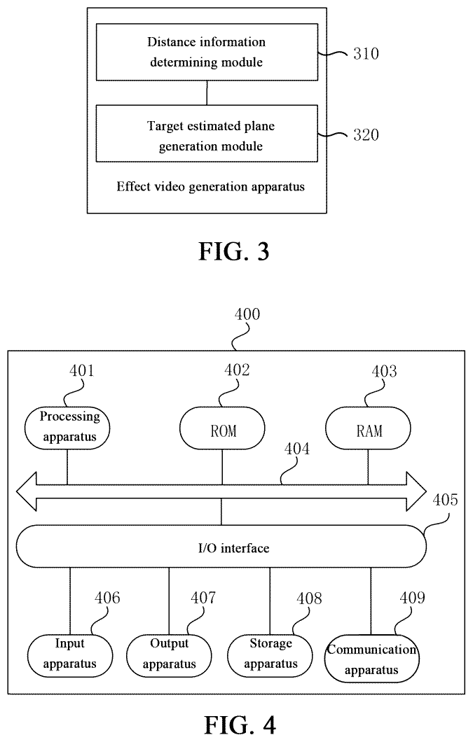

FIG. 3 is a schematic structural diagram of an effect video generation apparatus according to Embodiment III of the present disclosure. As shown in FIG. 3, the apparatus includes: a distance information determining module 310 and a target estimated plane generation module 320.

The distance information determining module 310 is configured to: when it is detected that a current video frame to be processed includes point cloud data to be processed, determine distance information between the point cloud data to be processed and at least one historically estimated plane, wherein the historically estimated plane is determined based on historical point cloud data to be processed.

The target estimated plane generation module 320 is configured to: if the distance information and a data volume of the point cloud data to be processed satisfy a plane estimation condition, perform plane estimation on the point cloud data to be processed based on a random sample consensus algorithm to generate a target estimated plane, so as to display, based on each estimated plane, a target effect corresponding to the current video frame to be processed and obtain a target effect video frame.

Optionally, the distance information determining module 310 is configured to: determine the distance information between the point cloud data to be processed and the at least one historically estimated plane based on coordinate information of the point cloud data to be processed and plane information of the at least one historically estimated plane.

Based on the plurality of technical solutions mentioned above, the target estimated plane generation module 320 includes a data volume accumulation unit for point cloud data to be processed and a target estimated plane generation unit.

The data volume accumulation unit for point cloud data to be processed is configured to: if the distance information is greater than a preset distance threshold in the plane estimation condition, accumulate the data volume of the point cloud data to be processed to obtain a current data volume.

The target estimated plane generation unit is configured to: if the current data volume reaches a data volume threshold in the plane estimation condition, perform, based on the random sample consensus algorithm, plane estimation processing on each piece of currently stored point cloud data to be processed to generate the target estimated plane.

Based on the plurality of technical solutions mentioned above, the effect video generation apparatus further includes a fusion module for point cloud data to be processed.

The fusion module for point cloud data to be processed is configured to: if the distance information is less than a preset distance threshold in the plane estimation condition, determine a target historically estimated plane corresponding to the point cloud data to be processed, and fuse the point cloud data to be processed to the target historically estimated plane.

Based on the plurality of technical solutions mentioned above, the effect video generation apparatus further includes a storage module for point cloud data to be processed.

The storage module for point cloud data to be processed is configured to: if the current data volume does not reach the data volume threshold, accumulate the current data volume, and store the point cloud data to be processed, so as to perform, in a case that the current data volume reaches the data volume threshold, plane estimation processing on the stored point cloud data to be processed to obtain the target estimated plane.

Based on the plurality of technical solutions mentioned above, the effect video generation apparatus further includes an estimated plane update module.

The estimated plane update module is configured to: if it is detected again that the video frame to be processed includes new point cloud data to be processed, add the target estimated plane into the historically estimated planes, and determine distance information between the point cloud data to be processed and the at least one historically estimated plane.

Based on the plurality of technical solutions mentioned above, the effect video generation apparatus further includes a target effect video frame generation module.

The target effect video frame generation module is configured to: if it is detected that the target effect is to be added to the current video frame to be processed, determine a target display position of the target effect based on touch point position information on a display interface and the at least one historically estimated plane; and display the target effect at the target display position to obtain a target effect video frame corresponding to the current video frame to be processed.

According to the technical solution provided by this embodiment, the distance information between the point cloud data to be processed and the at least one historically estimated plane is determined when it is detected that the current video frame to be processed includes the point cloud data to be processed. If the distance information and the data volume of the point cloud data to be processed satisfy the plane estimation condition, the random sample consensus algorithm is used to perform the plane estimation on the point cloud data to be processed to generate the target estimated plane, and the target effect corresponding to the current video frame to be processed is displayed based on each estimated plane to obtain the target effect video frame. This achieves the technical effect of dynamically constructing a plurality of planes in the three-dimension space, thus not only improving the flexibility of an effect adding operation, but also meeting the diversified demand of a user and enhancing the user experience.

The effect video generation apparatus provided by this embodiment of the present disclosure can implement the effect video generation method provided by any embodiment of the present disclosure, and has corresponding functional modules for implementing the method and corresponding effects.

The multiple units and modules included in the above apparatus are only divided according to a functional logic, but are not limited to the above division, as long as the corresponding functions can be achieved. In addition, the names of the multiple functional units are only for the purpose of distinguishing and are not used to limit the protection scope of the embodiments of the present disclosure.

### Embodiment IV

FIG. 4 is a schematic structural diagram of an electronic device according to Embodiment IV of the present disclosure. Reference is now made to FIG. 4 below, which illustrates a schematic structural diagram of an electronic device (namely, a terminal device or a server in FIG. 4) 400 suitable for implementing an embodiment of the present disclosure. The terminal device in this embodiment of the present disclosure may include mobile terminals such as a mobile phone, a laptop, a digital broadcast receiver, a Personal Digital Assistant (PDA), a Portable Android Device (PAD), a Portable Multimedia Player (PMP), an in-vehicle terminal (such as an in-vehicle navigation terminal), and fixed terminals such as a digital television (TV) and a desktop computer. The electronic device shown in FIG. 4 is only an example and should not impose any limitations on the functionality and scope of use of the embodiments of the present disclosure.

As shown in FIG. 4, the electronic device 400 may include a processing apparatus (such as a central processing unit and a graphics processing unit) 401. The processing apparatus 401 can perform various appropriate actions and processing according to programs stored in a Read-Only Memory (ROM) 402 or loaded from a storage apparatus 408 to a Random Access Memory (RAM) 403. Various programs and data required for operations of the electronic device 400 may also be stored in the RAM 403. The processing apparatus 401, the ROM 402, and the RAM 403 are connected to each other through a bus 404. An Input/Output (I/O) interface 405 is connected to the bus 404 too.

Following apparatuses can be connected to the I/O interface 405: an input apparatus 406 including, for example, a touch screen, a touchpad, a keyboard, a mouse, a camera, a microphone, an accelerometer, and a gyroscope; an output apparatus 407 including, for example, a Liquid Crystal Display (LCD), a speaker, and a vibrator; a memory 408 including, for example, a magnetic tape and a hard disk drive; and a communication apparatus 409. The communication apparatus 409 can allow the electronic device 400 to wirelessly or wiredly communicate with other devices to exchange data. Although FIG. 4 shows the electronic device 400 with various apparatuses, the electronic device is not required to implement or have all the apparatuses shown, and can alternatively implement or have more or fewer apparatuses.

According to the embodiments of the present disclosure, the process described in the reference flowchart above can be implemented as a computer software program. For example, the embodiments of the present disclosure include a computer program product, including a computer program carried on a non-transitory computer-readable medium, and the computer program includes program codes used for performing the methods shown in the flowcharts. In such an embodiment, the computer program may be downloaded and installed from a network through the communication apparatus 409, or installed from the memory 408, or installed from the ROM 402. When the computer program is executed by the processing apparatus 401, the above-mentioned functions defined in the methods of the embodiments of the present disclosure are executed.

Messages or names of information exchanged between a plurality of apparatuses in the implementations of the present disclosure are only for illustrative purposes and are not intended to limit the messages or the scope of the information.

The electronic device provided by this embodiment of the present disclosure and the effect video generation method provided in the above embodiment belong to the same concept. Technical details not described in this embodiment can be found in the above embodiment, and this embodiment has the same effects as the above embodiment.

### Embodiment V

This embodiment of the present disclosure provides a computer storage medium, having a computer program stored thereon. The program, when run by a processor, implements the effect video generation method provided in the above embodiment.

The computer-readable medium mentioned in the present disclosure can be a computer-readable signal medium, a computer-readable storage medium, or any combination of the computer-readable signal medium and the computer-readable storage medium. The computer-readable storage medium can be, for example, electric, magnetic, optical, electromagnetic, infrared, or semiconductor systems, apparatuses, or devices, or any combination of the above. The computer-readable storage medium may include: an electrical connection with one or more wires, a portable computer disk, a hard disk drive, a RAM, a ROM, an Erasable Programmable Read Only Memory (EPROM), a flash memory, an optical fiber, a Compact Disc Read-Only Memory (CD-ROM), an optical storage device, a magnetic storage device, or any suitable combination of the above components. In the present disclosure, the computer-readable storage medium may be any tangible medium that contains or stores a program, and the program can be used by or in combination with an instruction execution system, apparatus, or device. In the present disclosure, the computer-readable signal media may include data signals propagated in a baseband or as part of a carrier wave, which carries computer-readable program codes. The propagated data signals can be in various forms, including: electromagnetic signals, optical signals, or any suitable combination of the above. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including: a wire, an optical cable, a Radio Frequency (RF), and the like, or any suitable combination of the above.

In some implementations, clients and servers can communicate using any currently known or future developed network protocol such as a HyperText Transfer Protocol (HTTP), and can intercommunicate and be interconnected with digital data in any form or medium (for example, a communication network). Examples of the communication network include a Local Area Network (LAN), a Wide Area Network (WAN), an internet (such as an Internet), a point-to-point network (such as an ad hoc point-to-point network, and any currently known or future developed network.

The computer-readable medium may be included in the electronic device or exist alone and is not assembled into the electronic device.

The above computer-readable medium carries one or more programs. When the one or more programs are executed by the electronic device, the electronic device is caused to:
when it is detected that a current video frame to be processed includes point cloud data to be processed, determine distance information between the point cloud data to be processed and at least one historically estimated plane, wherein the at least one historically estimated plane is determined based on historical point cloud data to be processed; and
if the distance information and a data volume of the point cloud data to be processed satisfy a plane estimation condition, perform plane estimation on the point cloud data to be processed based on a random sample consensus algorithm to generate a target estimated plane, so as to display, based on each estimated plane, a target effect corresponding to the current video frame to be processed and obtain a target effect video frame.

Computer program codes for performing the operations of the present disclosure may be written in one or more programming languages or a combination thereof. The above programming languages include an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a LAN or a WAN, or can be connected to an external computer (for example, through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation may be implemented by using a combination of dedicated hardware and a computer instruction.

The units described in the embodiments of the present disclosure can be implemented through software or hardware. The name of the unit does not constitute a limitation on the unit itself. For example, the first obtaining unit can also be described as “a unit that obtains at least two Internet protocol addresses”.

The functions described herein above may be performed, at least in part, by one or a plurality of hardware logic components. For example, example hardware logic components that can be used include: a Field Programmable Gate Array (FPGA), an Application Specific Integrated Circuit (ASIC), Application Specific Standard Parts (ASSP), a System on Chip (SOC), a Complex Programmable Logic Device (CPLD), and the like.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include an electronic, magnetic, optical, electromagnetic, infrared, or semiconductor system, apparatus, or device, or any suitable combination of the above content. The machine-readable storage medium includes an electrical connection based on one or more wires, a portable computer disk, a hard disk drive, a RAM, a ROM, an EPROM or flash memory, an optical fiber, a portable CD-ROM, an optical storage device, a magnetic storage device, or any suitable combinations of the above content. The storage medium may be a non-transitory storage medium.

According to one or more embodiments of the present disclosure, [Example I] provides an effect video generation method. The method includes:
when it is detected that a current video frame to be processed includes point cloud data to be processed, determining distance information between the point cloud data to be processed and at least one historically estimated plane, wherein the historically estimated plane is determined based on historical point cloud data to be processed; and
if the distance information and a data volume of the point cloud data to be processed satisfy a plane estimation condition, perform plane estimation on the point cloud data to be processed based on a random sample consensus algorithm to generate a target estimated plane, so as to display, based on each estimated plane, a target effect corresponding to the current video frame to be processed and obtain a target effect video frame.

According to one or more embodiments of the present disclosure, [Example II] provides an effect video generation method. The method further includes:
optionally, determining the distance information between the point cloud data to be processed and the at least one historically estimated plane based on coordinate information of the point cloud data to be processed and plane information of the at least one historically estimated plane.

According to one or more embodiments of the present disclosure, [Example III] provides an effect video generation method. The method further includes:
optionally, if the distance information is greater than a preset distance threshold in the plane estimation condition, accumulating the data volume of the point cloud data to be processed to obtain a current data volume; and
if the current data volume reaches a data volume threshold in the plane estimation condition, performing, based on the random sample consensus algorithm, plane estimation processing on each piece of currently stored point cloud data to be processed to generate the target estimated plane.

According to one or more embodiments of the present disclosure, [Example IV] provides an effect video generation method. The method further includes:
optionally, if the distance information is less than the preset distance threshold in the plane estimation condition, determining a target historically estimated plane corresponding to the point cloud data to be processed is determined, and fusing the point cloud data to be processed to the target historically estimated plane.

According to one or more embodiments of the present disclosure, [Example V] provides an effect video generation method. The method further includes:
optionally, in a case that the current data volume does not reach the data volume threshold, accumulating the current data volume, and storing the point cloud data to be processed, so as to perform, when the current data volume reaches the data volume threshold, plane estimation processing on the stored point cloud data to be processed to obtain the target estimated plane.

According to one or more embodiments of the present disclosure, [Example VI] provides an effect video generation method. The method further includes:
optionally, in a case that it is detected again that the video frame to be processed includes new point cloud data to be processed, adding the target estimated plane into the historically estimated planes, and determining distance information between the point cloud data to be processed and the at least one historically estimated plane.

According to one or more embodiments of the present disclosure, [Example VII] provides an effect video generation method. The method further includes:
optionally, when it is detected that the target effect is to be added to the current video frame to be processed, determining a target display position of the target effect based on touch point position information on a display interface and the at least one historically estimated plane; and
displaying the target effect at the target display position to obtain a target effect video frame corresponding to the current video frame to be processed.

According to one or more embodiments of the present disclosure, [Example VIII] provides an effect video generation apparatus. The apparatus includes:
a distance information determining module, configured to: when it is detected that a current video frame to be processed includes point cloud data to be processed, determine distance information between the point cloud data to be processed and at least one historically estimated plane, wherein the historically estimated plane is determined based on historical point cloud data to be processed; and
a target estimated plane generation module, configured to: if the distance information and a data volume of the point cloud data to be processed satisfy a plane estimation condition, perform plane estimation on the point cloud data to be processed based on a random sample consensus algorithm to generate a target estimated plane, so as to display, based on each estimated plane, a target effect corresponding to the current video frame to be processed and obtain a target effect video frame.

In addition, although multiple operations are depicted in a specific order, this should not be understood as requiring these operations to be executed in the specific order shown or in a sequential order. In certain environments, multitasking and parallel processing may be advantageous. Similarly, although a plurality of implementation details are included in the above discussion, these should not be interpreted as limiting the scope of the present disclosure. Some features described in the context of individual embodiments can also be combined and implemented in a single embodiment. On the contrary, various features that are described in the context of the single embodiment may also be implemented in a plurality of embodiments separately or in any suitable sub-combinations.

Although the subject matter has been described in a language specific to structural features and/or method logical actions, the subject matter limited in the attached claims may not necessarily be limited to the specific features or actions described above. On the contrary, the specific features and actions described above are only exemplary forms for implementing the claims.

1. An effect video generation method, comprising:
in a case that it is detected that a current video frame to be processed comprises point cloud data to be processed, determining distance information between the point cloud data to be processed and at least one historically estimated plane, wherein the at least one historically estimated plane is determined based on historical point cloud data to be processed; and
in a case that the distance information and a data volume of the point cloud data to be processed satisfy a plane estimation condition, performing plane estimation on the point cloud data to be processed based on a random sample consensus algorithm to generate a target estimated plane, so as to display, based on each estimated plane, a target effect corresponding to the current video frame to be processed and obtain a target effect video frame.

2. The method according to claim 1, wherein determining the distance information between the point cloud data to be processed and the at least one historically estimated plane comprises:
determining the distance information between the point cloud data to be processed and the at least one historically estimated plane based on coordinate information of the point cloud data to be processed and plane information of the at least one historically estimated plane.

3. The method according to claim 1, wherein in a case that the distance information and the data volume of the point cloud data to be processed satisfy the plane estimation condition, performing plane estimation on the point cloud data to be processed based on the random sample consensus algorithm to generate the target estimated plane comprises:
in a case that the distance information is greater than a preset distance threshold in the plane estimation condition, accumulating the data volume of the point cloud data to be processed to obtain a current data volume; and
in a case that the current data volume reaches a data volume threshold in the plane estimation condition, performing, based on the random sample consensus algorithm, plane estimation processing on each piece of currently stored point cloud data to be processed, to generate the target estimated plane.

4. The method according to claim 1, further comprising:
in a case that the distance information is less than a preset distance threshold in the plane estimation condition, determining a target historically estimated plane corresponding to the point cloud data to be processed, and fusing the point cloud data to be processed to the target historically estimated plane.

5. The method according to claim 3, further comprising:
in a case that the current data volume does not reach the data volume threshold, accumulating the current data volume, and storing the point cloud data to be processed, so as to perform, in a case that the current data volume reaches the data volume threshold, plane estimation processing on the stored point cloud data to be processed to obtain the target estimated plane.

6. The method according to claim 1, further comprising:
in a case that it is detected again that the video frame to be processed comprises new point cloud data to be processed, adding the target estimated plane into the at least one historically estimated plane, and determining distance information between the point cloud data to be processed and the at least one historically estimated plane.

7. The method according to claim 1, further comprising:
in a case that it is detected that the target effect is to be added to the current video frame to be processed, determining a target display position of the target effect based on touch point position information on a display interface and the at least one historically estimated plane; and
displaying the target effect at the target display position to obtain a target effect video frame corresponding to the current video frame to be processed.

8. (canceled)

9. An electronic device, comprising:
one or more processors; and
a storage apparatus, configured to store one or more programs,
wherein the one or more programs, when executed by the one or more processors, cause the one or more processors to implement a method comprising:
in a case that it is detected that a current video frame to be processed comprises point cloud data to be processed, determining distance information between the point cloud data to be processed and at least one historically estimated plane, wherein the at least one historically estimated plane is determined based on historical point cloud data to be processed; and
in a case that the distance information and a data volume of the point cloud data to be processed satisfy a plane estimation condition, performing plane estimation on the point cloud data to be processed based on a random sample consensus algorithm to generate a target estimated plane, so as to display, based on each estimated plane, a target effect corresponding to the current video frame to be processed and obtain a target effect video frame.

10. A non-transitory computer readable storage medium comprising computer-executable instructions, wherein the computer-executable instructions, when executed by a computer processor, are configured to:
in a case that it is detected that a current video frame to be processed comprises point cloud data to be processed, determine distance information between the point cloud data to be processed and at least one historically estimated plane, wherein the at least one historically estimated plane is determined based on historical point cloud data to be processed; and
in a case that the distance information and a data volume of the point cloud data to be processed satisfy a plane estimation condition, perform plane estimation on the point cloud data to be processed based on a random sample consensus algorithm to generate a target estimated plane, so as to display, based on each estimated plane, a target effect corresponding to the current video frame to be processed and obtain a target effect video frame.

11. The electronic device according to claim 9, wherein the one or more processors are caused to:
determine the distance information between the point cloud data to be processed and the at least one historically estimated plane based on coordinate information of the point cloud data to be processed and plane information of the at least one historically estimated plane.

12. The electronic device according to claim 9, wherein the one or more processors are caused to:
in a case that the distance information is greater than a preset distance threshold in the plane estimation condition, accumulate the data volume of the point cloud data to be processed to obtain a current data volume; and
in a case that the current data volume reaches a data volume threshold in the plane estimation condition, perform, based on the random sample consensus algorithm, plane estimation processing on each piece of currently stored point cloud data to be processed, to generate the target estimated plane.

13. The electronic device according to claim 9, wherein the one or more processors are further caused to:
in a case that the distance information is less than a preset distance threshold in the plane estimation condition, determine a target historically estimated plane corresponding to the point cloud data to be processed, and fusing the point cloud data to be processed to the target historically estimated plane.

14. The electronic device according to claim 12, wherein the one or more processors are further caused to:
in a case that the current data volume does not reach the data volume threshold, accumulate the current data volume, and store the point cloud data to be processed, so as to perform, in a case that the current data volume reaches the data volume threshold, plane estimation processing on the stored point cloud data to be processed to obtain the target estimated plane.

15. The electronic device according to claim 9, wherein the one or more processors are further caused to:
in a case that it is detected again that the video frame to be processed comprises new point cloud data to be processed, add the target estimated plane into the at least one historically estimated plane, and determine distance information between the point cloud data to be processed and the at least one historically estimated plane.

16. The electronic device according to claim 9, wherein the one or more processors are further caused to:
in a case that it is detected that the target effect is to be added to the current video frame to be processed, determine a target display position of the target effect based on touch point position information on a display interface and the at least one historically estimated plane; and
display the target effect at the target display position to obtain a target effect video frame corresponding to the current video frame to be processed.

17. The non-transitory computer readable storage medium according to claim 10, wherein the computer-executable instructions are configured to:
determine the distance information between the point cloud data to be processed and the at least one historically estimated plane based on coordinate information of the point cloud data to be processed and plane information of the at least one historically estimated plane.

18. The non-transitory computer readable storage medium according to claim 10, wherein the computer-executable instructions are configured to:
in a case that the distance information is greater than a preset distance threshold in the plane estimation condition, accumulate the data volume of the point cloud data to be processed to obtain a current data volume; and
in a case that the current data volume reaches a data volume threshold in the plane estimation condition, perform, based on the random sample consensus algorithm, plane estimation processing on each piece of currently stored point cloud data to be processed, to generate the target estimated plane.

19. The non-transitory computer readable storage medium according to claim 10, wherein the computer-executable instructions are further configured to:
in a case that the distance information is less than a preset distance threshold in the plane estimation condition, determine a target historically estimated plane corresponding to the point cloud data to be processed, and fusing the point cloud data to be processed to the target historically estimated plane.

20. The non-transitory computer readable storage medium according to claim 10, wherein the computer-executable instructions are further configured to:
in a case that it is detected again that the video frame to be processed comprises new point cloud data to be processed, add the target estimated plane into the at least one historically estimated plane, and determine distance information between the point cloud data to be processed and the at least one historically estimated plane.

21. The non-transitory computer readable storage medium according to claim 10, wherein the computer-executable instructions are further configured to:
in a case that it is detected that the target effect is to be added to the current video frame to be processed, determine a target display position of the target effect based on touch point position information on a display interface and the at least one historically estimated plane; and
display the target effect at the target display at the target display position to obtain a target effect video frame corresponding to the current video frame to be processed.
